(19) United States
(12) Patent Application Publication
(10) Pub. No.: US 2009/0045586 A1
(43) Pub. Date: Feb. 19, 2009

(54) Method For Producing Rotary and/or Stationary Seal Rings of a Mechanical Face Seal by Means of Laser Hardening

(76) Inventor: Franz-Gunter Cantow, Huckeswagen (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/094,027

(22) PCT Filed: Sep. 22, 2006
(86) PCT No.: PCT/DE2006/001691

§ 371 Date: May 16, 2008

(30) Foreign Application Priority Data
Nov. 17, 2005 (DE) 10 2005 054 709.5

(51) Int. Cl. F16J 15/16; B21D 53/88

(52) U.S. Cl. 277/406; 29/888.3

(57) ABSTRACT

Process for producing sliding and/or mating rings which can be used for a sliding-ring seal, by manufacturing sliding and/or mating rings by casting from a grey cast iron material with a high thermal conductivity, by machining at least in the subsequent sealing zone and finally by laser-hardening the surface of the respective sealing zone. It is preferable to use a grey iron having the composition (%) C: 3.4-3.9, Si: 2.2-3.2, Mn: 0.5-1, Cr: 0.1-0.4, V: max, 0.15, Cu: 0.1-0.7, P: 0.3-0.6, S: max. 0.13, remainder Fe and inevitable impurities.

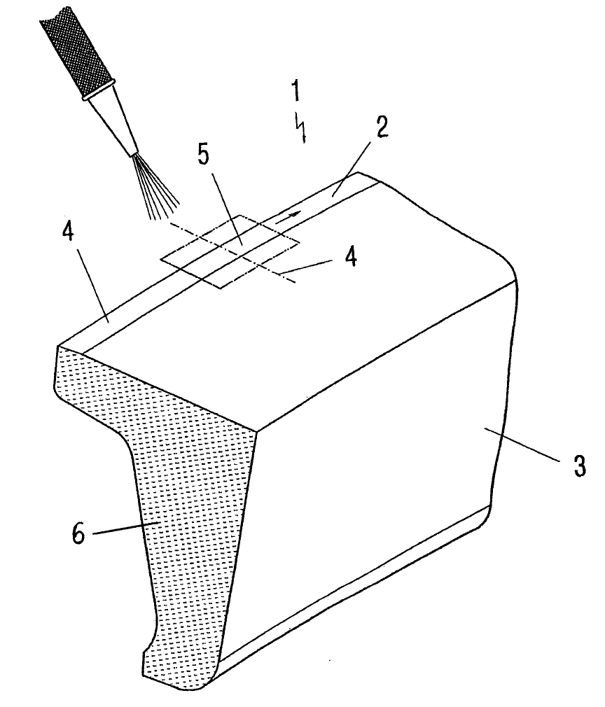

The invention relates to a method for producing rotary and/or stationary seal rings to be used in a mechanical face seal.

Mechanical face seals are made of a variety of chill casting materials, nickel casting, steel, or sheet steel. These materials are used depending on the application and supplier. Previously, the limit for the controllable circumferential velocity in chill casting or comparable materials was a value of no more than 10 m/s, in relation to the sealing surface.

In U.S. Pat. No. 4,094,514, a metal alloy composition having improved wear resistance was disclosed, which can be used for the production of rotary and/or stationary seal rings for mechanical face seals. The alloy has the following composition:

### C 3.10-3.35%

### Mn max. 1.0%

Si about 0.75 to about 1.40%
Cr about 16.5 to about 19.0%
V about 0.75 to about 2.0%
Mo about 2.5 to about 4.0%
Co about 0.25 to about 1.25%
W about 1.75 to about 3.0%

### P <0.04%

### S <0.04%

Fe remainder and unavoidable impurities.

JP-A 60200950 discloses a mechanical face seal with high wear resistance of the sealing surface. The following chemical composition is provided:

### C 2.2 to 3.8%

### Si 2.0 to 4.0%

### Mn 0.4 to 2.0%

### Cu 0.5 to 4.0%

### Ni ≦4.0%

### Cr, Ti, W, V 0.3 to 1.3%

Mo 0.3 to 1.5% (if necessary)

### P ≦0.5%

### S ≦0.2%

Fe remainder and unavoidable impurities.

The sealing surface was remelted and cooled to produce a defined surface structure.

RU-C1 2152550 discloses a mechanical face seal and a method for the production thereof. The sealing surface of the rotary and/or stationary seal rings should have regions characterized by higher and lower hardness, viewed in the radial direction. Sections of higher hardness in the sealing area are produced by surface hardening or appropriate alloying, if necessary in conjunction with laser radiation.

It is therefore the object of the invention to propose a method and a material, which allow mechanical face seals to be used also in regions of higher circumferential velocities (>10 m/s).

This object is achieved by a method for producing rotary and/or stationary seal rings that can be used for a mechanical face seal in that the rotary and/or stationary seal rings are cast from gray cast iron material having high thermal conductivity, machined at least in the subsequent sealing area, and then subjected to a laser hardening process for the surface of the respective sealing area.

A preferred chemical composition for the rotary and/or stationary seal rings having high thermal conductivity is as follows:

### C 3.4 to 3.9%

### Si 2.2 to 3.2%

### Mn 0.5 to 1.0%

### Cr 0.1 to 0.4%

### V max. 0.15%

### Cu 0.1-0.7%

### P 0.3 to 0.6%

### S max. 0.13%

Fe remainder and unavoidable impurities.

This object is achieved by rotary and stationary seal rings of a mechanical face seal, comprising a base body made of gray cast iron material having high thermal conductivity and having a substantially angular cross-section, the base body comprising a sealing area that extends substantially in the radial plane, wherein at least the sealing area is provided with a laser-hardened surface.

The rotary and/or stationary seal rings are preferably used as sealing elements in the region of a running gear seal.

According to a further idea of the invention, the rotary and/or stationary seal rings are to be used in the region of a pinion shaft of a vehicle, particularly at circumferential velocities in the range from 20 to 35 m/s.

The gray cast iron material used has good thermal conductivity. This is important in order to quickly pass the high friction heat occurring at the listed high circumferential velocities on to the lubricating/cooling medium. As a result of the inventive laser hardening of the surface of the sealing area, in addition to the increase in the circumferential velocities optimized for running gear seals also considerably higher wear resistance of the laser-hardened surface can be achieved.

Tests, such as those performed with pinion shaft seals, allowed circumferential velocities of at least 25 m/s without any galling.

The metal rotary and/or stationary seal rings produced by casting are easy to manufacture because the material can be machined on conventional machine tools, for example by means of turning. Through simple adjustment options, laser-hardening devices enable the hardening of different diameters of the rotary and/or stationary seal rings.

Due to the inventive laser hardening of the surface of the sealing area, also the previously used coating operations can be eliminated, including the associated high material losses in the operating state of the mechanical face seal.

The subject matter of the invention is shown in the FIGURE based on an exemplary embodiment and is described as follows: The only FIGURE shows a rotary or stationary seal ring 1 of a mechanical face seal, which is not shown in detail. The rotary or stationary seal ring 1 is made of a gray cast iron material having high thermal conductivity and, for example, has the following composition (in mass %):

### C 3.65%

### Si 2.55%

### Mn 0.8%

### Cr 0.25%

### V 0.10%

### Cu 0.45%

### P 0.35%

### S 0.08%

Fe remainder and unavoidable impurities.

Similar compositions within the spread range of the elements are of course also conceivable.

The rotary seal ring has a substantially angular cross-section and, in addition to an outer circumferential surface 2 and an inner circumferential surface 3, has a sealing area 4. Subsequent to the casting operation, at least the sealing area 4 undergoes a machining operation. In order to obtain an application, for example, as a running gear seal for circumferential velocities in the range of 30 m/s, the sealing area 4 is subjected to a surface hardening step using a laser tool.

1-5. (canceled)

6. A method for making seal rings for a mechanical face seal, comprising coasting the seal rings from grey cast iron, machining at least a sealing area of the seal rings, and then laser hardening the machined sealing area.

7. The method of claim 6, wherein the grey iron is selected as a non-alloyed, non-heat treated grey cast iron with flake graphite having the following chemical composition (in mass %):
C 3.4 to 3.9%
Si 2.2 to 3.2%
Mn 0.5 to 1.0%
Cr 0.1 to 0.4%
V max. 0.15%
Cu 0.1-0.7%
P 0.3 to 0.6%
S max. 0.13%
Fe remainder and unavoidable impurities.

8. A seal ring of a mechanical face seal, comprising:
a base body made of grey cast iron having a substantially angular cross section;
a sealing area on said base body extending substantially in a radial plane; and
wherein said sealing area has a laser hardened surface.

9. The seal ring of claim 7, wherein said seal ring comprises a seal ring of a running gear seal.

10. The seal ring of claim 7, wherein the seal ring comprises a seal ring of a vehicular pinion shaft.
